(19) United States
(12) Patent Application Publication
(10) Pub. No.: US 2008/0103939 A1
(43) Pub. Date: May 1, 2008

(54) Computerized-Sensing System For A Mini Bar

(75) Inventor: David Gibb, Berkshire (GB)

Correspondence Address: PEARNE & GORDON LLP, 1801 EAST 9TH STREET, SUITE 1200, CLEVELAND, OH, 44114-3108, US

(73) Assignee: AMS Automatic MiniBar Systems LTD, Berkshire (GB)

(21) Appl. No.: 10/565,252

(22) PCT Filed: Jul. 29, 2003
(86) PCT No.: PCT/EP03/08379

§ 371 Date: Feb. 21, 2007

(51) Int. Cl. G06Q 30/00

(52) U.S. Cl. 705/28

(57) ABSTRACT

Dispensing system with at least one dispenser 1 for articles that are available to be dispensed, preferably in form of a mini bar, an administering system for billing articles and/or administering the stock of the articles to be dispensed, or at least an interface 6 to such an administering system, whereby said dispenser 1 comprises at least one store area 3. Said one store area 3 allows the simultaneous storing of several preferably different articles, whereby the articles can be removed and placed back after inspection by the customer. As long as the customer only inspects the articles he will not be charged for the selling price of the articles. The articles can be freely positioned on the store area 3, whereby said store area is monitored by a detection device which is able to detect at least after a certain time whether an article has been removed. This detection works independently from the positions in said store area occupied by remaining articles and occupied formally by said removed article. Said detection device comprises a detecting sensor arrangement 4 that generates a signal enabling to calculate the removal of said removed article and a data processing unit 5 processing said signal by comparing it with stored data determining thus the removal of said removed article for the purpose of billing.

The present invention relates to a dispensing system with at least one dispenser for articles that are available to be dispensed and a remote inventory control system for billing dispensed articles and/or administering the stock of the articles according to the preamble of claim 1.

The invention has been developed primarily as a dispensing system for use in so called minibars consisting of a refrigerator and/or external non-refrigerated sections refrigerators of hotel rooms (so called mini bars) and will be described hereinafter with reference to that application. We would like to point out, however, that the invention is not limited to the particular field of use and it is also suitable for other dispensing devices and for use in other areas, whether those areas being private or common.

A potential difficulty faced by hotel operators is that the mini bar services that are provided are usually run at a loss or a minimal margin. This arises from a variety of factors. It is not unusual that a customer is not charged for the articles consumed from the mini bar because the customer forgets to notice the consumed articles when checking out. Another aspect is that it is quite labour-intensive to keep a mini bar well-filled at all times. Therefore, a variety of inventory control systems have been developed which enable a mini bar to communicate the dispense of goods to the central hotel computer.

Early systems provided a number of individual stowing compartments within the mini bar. A stowage compartment receives one or more articles to be dispensed and is closed by a door. As soon as the door is opened, or, at least, as soon as an article has been dispensed, i.e. as soon as the stowage compartment is emptied, the selling price of the article is charged.

Such systems have not been very successful because most guests are reluctant to buy an article if it seems not to be possible to take an article away for a closer inspection without being charged for this article.

Moreover, the manufacturing as well as the cleaning and the maintenance of a mini bar with a great number of individual compartments is time consuming.

More sophisticated constructions, for example the construction known from WO 02/056265 A1, do not use individual compartments but shelves providing special positions (e.g. in the form of deepenings) for each individual product to be dispensed. The bottom or the walls of the deepening are equipped with micro switches. The article presses down this micro switches as long as it rests in its position. After an article has been taken, the micro switches indicate that an article has been taken and sometime after this, the article is charged. Indeed, the guest has the possibility to take a product away for having a closer look at it and put it back if he cannot decide to buy the article. If the micro switches are installed in a hidden position, even the psychological barrier to take away a product can be avoided.

Problems may be caused by the fact that the individual products to be dispensed have an individual shape or size. Consequently it is necessary to provide different deepenings for different articles—it is obvious that a bottle of champagne may need a different deepening than a little bottle of water or juice. Moreover, if it is desired to change the variety of articles to be dispensed, it may become, as the case may be, necessary to replace one or more of the shelves supporting the switches. Finally, micro switches are delicate and it is labour intensive to clean a shelf with a number of deepenings and micro switches in case, for example, a beverage has been spilled.

It is the object of the invention to provide a dispensing system avoiding the above-mentioned disadvantages.

Accordingly, the invention provides a dispensing system with at least one dispenser for articles that are available to be dispensed, preferably in form of a mini bar, an administering system for billing dispensed articles and/or administering the stock of the articles available to be dispensed, or at least an interface to such administering system, said dispenser comprises at least one store area, said store area allows the simultaneous storing of a plurality of different articles, whereby the articles can be removed and placed back after inspection by the customer without being charged the selling price of the articles, whereby the articles can be positioned freely in the store area, and whereby said store area is monitored by a detection device which is able to detect, at least after a certain time, whether an article has been removed and which is preferable able to detect the identity of the removed article. In each case the detection will be independent from the position in said store area which has been previously occupied by said removed articles, whereby said detection device comprises a detection sensor arrangement that generates a signal enabling to calculate the removal and preferably the identity of said removed article and a data processing unit processing said signal by comparing it with storage data, thus determining only the removal of the said removed article or the removal and preferably the identity of said removed article for the purpose of billing and/or administering the stock of articles.

A preferred embodiment of the invention provides that the detecting sensor arrangement comprises a store area carried by a means or means for measuring the load on the store area and a data processing unit that comprises means for comparing data of an actual load of the store area with data of a former load of the store area and means for identifying the dispensed article by means of load difference.

Such a sensor arrangement works very quickly and reliable. The analysis of signals delivered by load sensoring is easy and requires not too much data processing power.

High precision load sensors are commercially available at low prices. Consequently the use of one or more load sensors allows to manufacture a dispensing system at competitive prices.

It is preferred that the store area, monitored by load sensors, is three point beared, each bearing area or point carries a load sensor. A three point bearing i.e. a statically defined bearing makes it easier to determine the actual load of the store area as precisely as required.

An alternative preferred embodiment provides that the detecting sensor arrangement comprises a pick-up equipment that supplies a full or part of digital images, of the store area and the articles stored in the store area and it provides further that the data processing unit comprises means for comparing data of an actual image of the store area with data of a former image of the store area and means for identifying the dispensed article by means of the difference between the images.

Such detecting sensor arrangement allows to a far extent the use of standard hardware. Moreover, a detecting sensor arrangement that delivers digital full image or images allows easily to realise a number of additional functions, e.g. the monitoring of the hygienic status of the dispenser or a remote default analysis, for example if an article is in an irregular position after being placed back by the customer or if a foreign item is to be detected—e.g. if a guest places one of his personal travel utensils (maybe a pill box or a sun blocker) in the mini bar in order to keep it cool. For such purposes the digital full image can be displayed on a central monitor. Thereby, a quick and easy checking by the service team is possible.

Another preferred embodiment provides that the pick-up equipment is arranged above the store area so that it pictures the store area and the articles stored in the store area from above. The processing, i.e. the analysis of the picture is fasciliated if the picture is taken preferably from above and, dependent upon the storage depth, preferably from a central position above the store area.

Another preferred embodiment provides that the pick-up equipment is remote and takes the pictures of the store area by means of a mirror system or a glass fiber optics. Such construction makes it possible to accommodate the pick-up equipment, which requires not only a little space at a convenient position. Moreover, it is possible to use one single pick-up equipment in order to monitor a plurality of store areas by means of a movable mirror system or a number of glass fiber optics which are alternatively connected to the pick-up equipment by an appropriate optical shunt.

Another preferred embodiment provides that the detecting sensor arrangement comprises a light source illuminating the dispenser on demand, independently from the general illumination of the dispenser in order to enable the pick-up equipment to take a picture. Such light source makes it possible to take a picture while the housing of the dispenser is closed. It is thereby possible to take a picture without irritating the customer. Additionally, this makes sure that the customer does not disturb the process of taking a picture because the picture can be taken when the door is closed.

Another preferred embodiment provides that the light source consists of one or more incandescent light sources, preferably one or more diodes or an array of diodes. The use of incandescent light sources avoids a generation of heat within the housing of the dispenser. This is especially important if the dispenser is a refrigerator. Moreover, diodes require only very little space even if the light source consist of a plurality of diodes. A very uniformed illumination can be provided if the diodes are arranged symmetrically at different places. That helps to avoid shadowing which might falsify the recognition of the articles stored.

A further preferred embodiment provides that the detecting sensor arrangement comprises a plurality of sources emitting coherent light, preferably laser diodes, co-operating with an according number of light detectors, said light sources and said light detectors are arranged in such a way that the stored articles create a shadow image and that the data processing unit comprises means for comparing data of an actual shadow image with data of a former shadow image and means for identifying the dispensed article by means of the difference between the shadow images.

Such shadow image can be analysed with less expenditure compared to the analysis of a full image.

Another preferred embodiment provides that one or more light curtains that are provided in a number of different planes. It is advantageous if said planes are approximately perpendicular to the surface of the store area. The space above the store area is preferably limited in a manner that the articles to be stored in that store area cannot be stacked on top of each other.

Such construction avoids that one article may be shaded by another so that the shaded article cannot be properly detected.

Another preferred embodiment provides that the detecting sensor arrangement comprises a Radio Frequency Identification-Scanner (RFId-Scanner) which is able to communicate with transponder labels (so-called smart tags) attached to the articles to be dispensed. The RFId-technology allows a very easy monitoring of each individual article labelled with a smart tag. Moreover, the RFId-technology is extremely fail-safe because articles not carrying a smart tag are ignored.

Preferred embodiments of the invention will now be described with reference to the accompanying drawings:

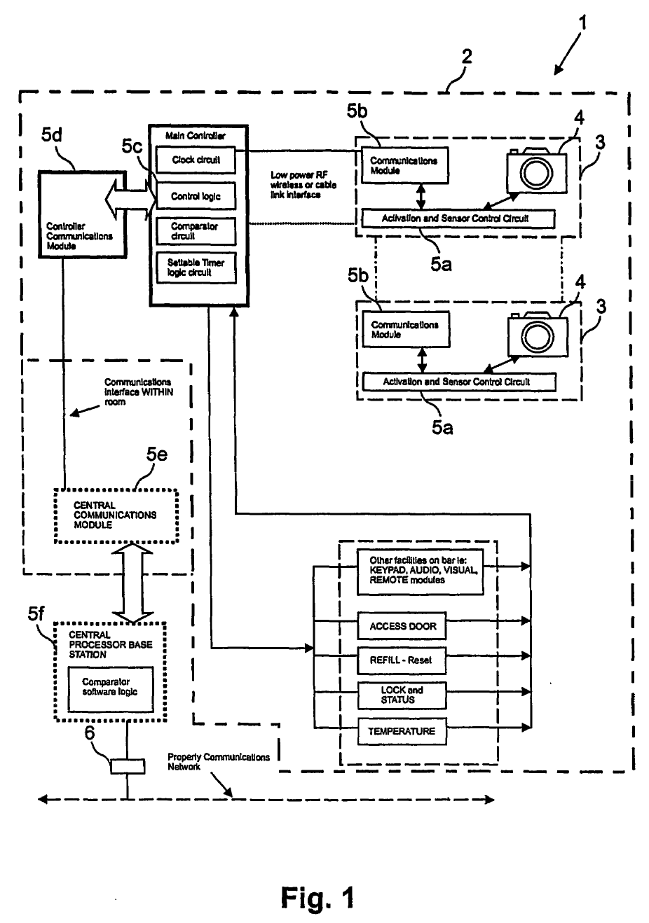

FIG. 1 shows an embodiment of the invention in general

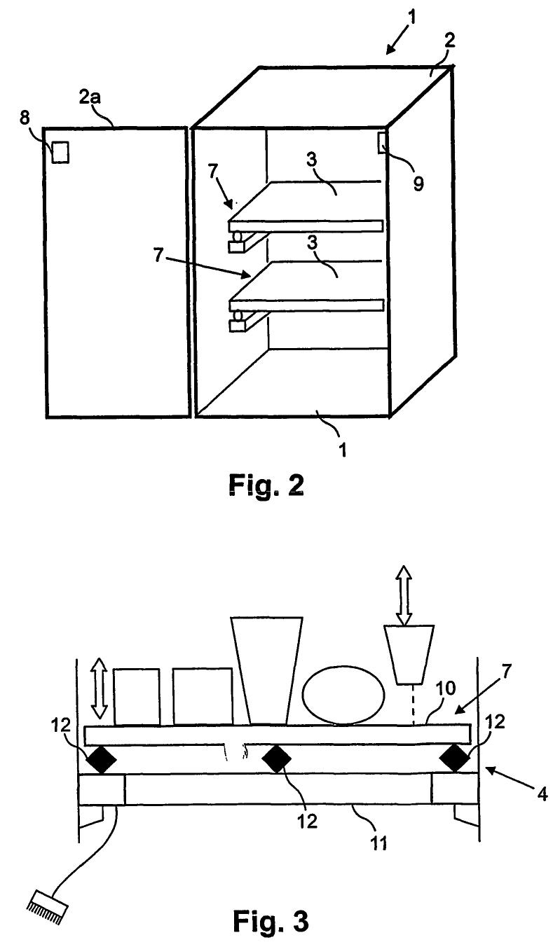

FIG. 2 shows a first embodiment of a dispenser for the inventive dispensing system in form of a mini bar with shelves beared on load sensors.

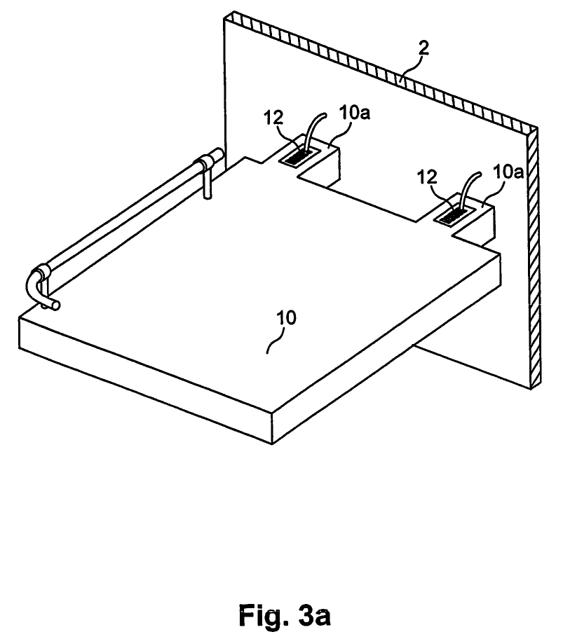

FIG. 3 shows a single shelf module to be used by the said first embodiment of the dispenser.

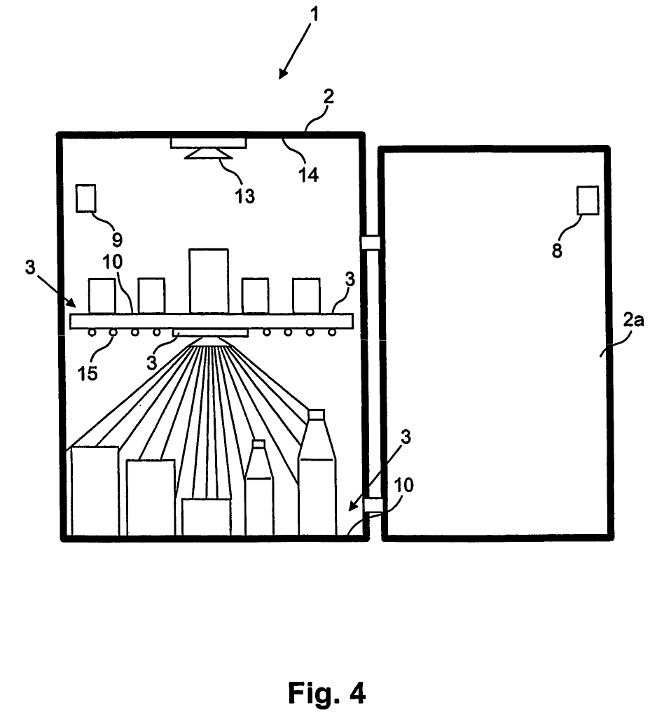

FIG. 4 shows a second embodiment of a dispenser for the inventive dispensing system in form of a mini bar with cameras taking digital images of the store areas.

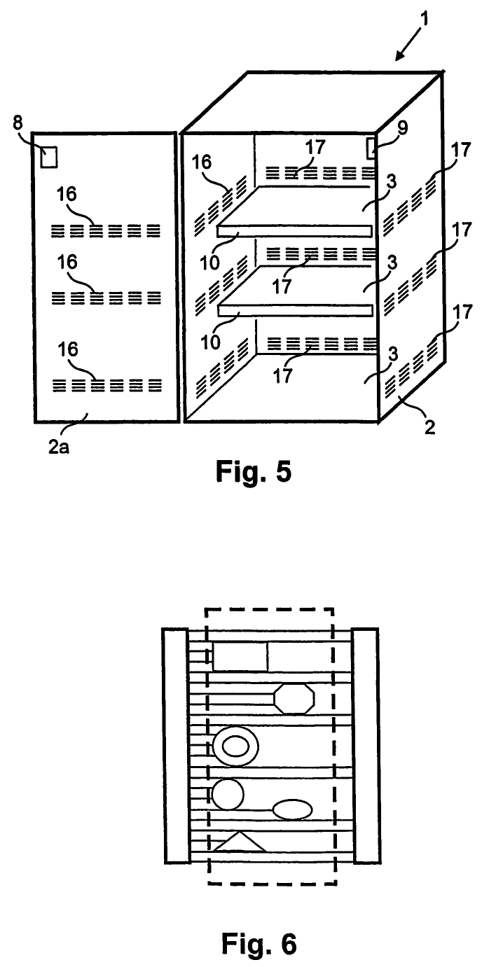

FIG. 5 shows a third embodiment of a dispenser for the inventive dispensing system in form of a mini bar with light curtains monitoring the store areas.

FIG. 6 illustrates details of the monitoring by light curtains.

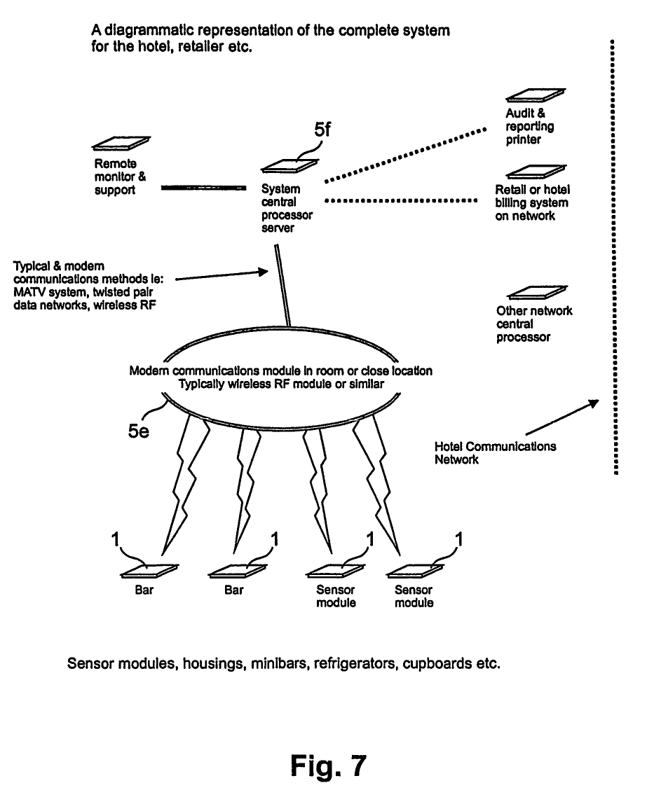

FIG. 7 shows another embodiment of the inventive system.

FIG. 1 grants an overview over an embodiment of the inventive system in general. The dash dotted lines show a casing 2 of a dispenser 1. The dispenser 1 comprises of one or more storing areas 3, may be in form of shelves, for displaying the goods to be dispensed. The storing areas 3 allow the simultaneous storing and display of the articles to be dispensed.

To each of the store areas 3 a detecting sensor arrangement 4 is assigned that generates a signal enabling to calculate the removal and the identity of the removed article. The calculation is done by a data processing unit 5 which may be comprise a number of components 5a, 5b, 5c, 5d, 5e, 5f. Said components may be fully or partially integrated into the housing 2 of the dispenser 1. As far as the embodiment shown by FIG. 1 is concerned, all components of the data processing unit are integrated into the housing 2 except for the central communications module 5e and except for the central processor base station 5f. In this embodiment, the central processor base station 5f is substantially involved into processing the signal stored data. Thus the removal and the identity of a removed article can be determined for the purpose of billing and/or administering the stock of articles. The administering system may be—for example—managed by the central processor 5f, otherwise the processor will communicate with the administering system via an interface 6. The central communications module 5e may be integrated into the casing 2 of the dispenser. Alternatively, it can be mounted in the room or in the floor in front of the room. In this case, one or more dispensers are served by the central communications module 5e.

FIG. 2 shows a first embodiment of a dispenser for the inventive dispensing system. The dispenser 1 has a box-like casing 2. That casing is preferably closed by a door 2a.

Such dispenser may be used for a variety of purposes in different fields of industry. Especially in the field of hotel industry such dispenser could be, for example, a mini bar, a cupboard or a part of a bathroom cabinet fitted with a mirror. In this last case the dispenser will dispense different kinds of toilet articles like bath foam, perfume, tooth paste and the like. Preferably the dispenser is a mini bar. Then casing 2 comprises a refrigerator unit (not shown).

Hereinafter it shall be assumed that the dispenser is a mini bar for the purpose of demonstration.

This embodiment makes use of a detecting sensor arrangement 4 which is based on the principle of load detecting. For that purpose the dispenser is equipped with one or more store areas 3 in the form of shelves resting on high precision load sensors as described hereinafter.

At first, reference is made to FIG. 2. The dispenser shown there is equipped with two shelf modules 7. However, dispensers with only one or more than two shelf modules 7 can be realised, too. The shelf modules 7 are supported by the side walls of the casing 2 by means of suitable girders. The casing 2 comprises preferably an electronic door lock 8 and an electronic door catch 9. The electronic door lock and catch include optionally a sensor module which signalises whether the door is presently open or not.

All necessary electronics is preferably mounted in a separate compartment on the backside of the casing 1 of the mini bar (not shown). However, this separate compartment can be on the underside, top or sides where it is convenient. Preferably a mini bar must be as silent as possible under operation. Therefore the electronics may be mounted on a heat sink which comes directly into contact with the cool inner refrigerator compartment. That way it is very easy to provide a sufficient cooling of the electronics without using a fan, which inevitably produces some noise.

The shelf module 7 provided for this embodiment is shown in FIG. 3.

The shelf module 7 consists of the shelf plate 10. The shelf plate 10 may rest on an optional shelf frame 11. By means of such shelf frame 11 the shelf module 7 can be designed as an integral unit which can be inserted into and removed from the mini bar with little effort, for example in order to vary the positioning of the shelf module to suit the differing heights of articles. However, the shelf module can be a solid part of the casing, too.

The shelf frame 11 is equipped with preferably three high-precision load sensors 12. To each side of the preferably “C”-shaped shelf frame 11 (the frame has an open side which is turned towards the door opening) one load sensor is attached. The shelf plate 10 is beared on said three load sensors 12. If only three load sensors are used, the expenditure with respect to the data processing is kept as low as possible. However it is not excluded to use four or more load sensors per shelf. The shelf plate 10 contacts the housing 2 only via the load sensors 12. No other contact can be found between the shelf plate 7 and the housing 2. The shelf plate 10 has a rigid design so that there is practically no wind or warp, even if the shelf plate is charged by the maximum load being admissible. Preferably, the shelf frame 11 (as far as optionally provided) has a very rigid design, too. For the sake of completeness, it has to be mentioned that it is alternatively possible to bear the shelf as shown by FIG. 3a. This construction uses an alternative shelf plate 10 which is fixed to the housing of the mini bar via a two areas 10a. The flexible areas 10a carry at least one detector 12, each. The load detectors 12 accomplish the load detection for example by measuring the elongation of the flexed areas 10a, i.e. the load detectors are resistance strain gauges in this example. The shelf plate 10 has no specific locations for articles. Preferably the shelf plate 10 has an even surface which makes the cleaning easier. The edges of the shelf plate facing towards the inner surfaces of the housing 2 should carry suitable spacers, for example railings (partially shown by FIG. 3a). Such railings avoid that articles may be positioned in such way that they come into frictional contact with the walls of the housing 2 or the door 2a.

The signal generated by the load sensors 12 is fed to a data processing unit 5 (not shown by FIG. 2). The data processing unit 5 is part of the detection device. The data processing unit may fully or partially be integrated into the casing 1 of the dispenser or it may be fully arranged remote. Based on the signals of the sensors 12, the data processing unit 5 is able to calculate the present weight of the shelf load and to compare it to the previous weight of the shelf load and for the more simpler system where the article is not recognised or defined, the signal generated is simply to qualify that there has been a change of state and something has been removed from the shelf plate.

The load sensors 12 are of any suitable type commercially available.

Preferably the signal of the load sensors 12 is compensated with respect to variations of the operational temperature of the sensor or its surrounding.

If sensors 12 with a very high precision are used, the system becomes as convenient and as fail-safe as possible. This is because nearly all different kinds of goods to be dispensed by a mini bar have, due to the different types of packages or bottles, a sufficient difference in weight, even if the nominal contents or the nominal weight is identical. Typically a 0.75 l champagne bottle itself has a different weight than 0.75 l a wine bottle. Even the different types of 0.75 l or 0.25 l wine bottles have a different weight. The only thing which has to be done in order to operate such a system using high precision sensors properly, is to control the effective weight of the products to be dispensed from time to time. In doing so, errors or any malfunction of the system due to modifications of the packing (in the meantime introduced by the manufacturer) can be avoided. For that purpose, the system may have a central scale (not shown). Such scale is preferably a kind of “smart scale” connected to the data processing system 5. That way, the system is able to learn about the statistical range of variations for the weight of each individual type of product. This improves the reliability of the system because the system will be able to better determine the identity of a product even if the weight of this individual product shows slight differences in the nominal weight of such a product—for whatever reason.

If it is desired to use less precise and therefore less costly sensors 12 it might be necessary to tune the range of products to be dispensed by the system. In other words, the operator of the system will in such case have to make sure, that there are no different products which have only such a slight difference in their nominal weights (or, more precise, in their possible range of real weights, see above) that the signals delivered by the sensors are not sufficient in order to differentiate between said products. At least the operator has to make sure that the pricing of such products does not differ. It is advantageous, to equip such system, too, with a scale connected to the data processing system 5 . Such “smart” scale may support the operator to tune the system by generating at least a warning if the weight of one type of product comes too close to the weight of another type of product (or, maybe, a combination of two other types of products and vice versa).

If it is desired to distinguish between different types of products having no sufficient difference in weight (like standardised 0.5 l bottles containing different kinds of beer) stickers or tags comprising a mass body may be fixed to such products.

The invention allows to realise a very low cost system, too. Such a low cost system uses very cheap sensors which may have a remarkable measuring inaccuracy. Such sensors may not be able to detect reliably whether a bottle of beer with an overall weight of 520 grams or a bottle of juice with an overall weight of 526 grams has been removed. However, this is not necessary if the mini bar's equipment with articles to be dispensed is tuned accordingly. It could, for example, be taken into consideration to display nothing but articles having a clearly different weight and the uniform price “A” on the lowest shelf and to display nothing but articles having a clearly different weight and the uniform price “B” on the next higher following shelf. As soon as the detection device signalises that one ore more articles have eventually been taken away from one of the shelves, the guest is charged with the uniform price “A” for these articles. This may occur even if the guest has put the concerned articles back on the other shelf with articles having the uniform price “B”. In this case, the guest will complain that he did not consume the charged articles. This will be checked and if the guest is correct, the bill will be corrected accordingly. Even such a simple system ensures that the guest will not leave without being charged for consumed articles. It needs not to be mentioned that such a tuning works even better if each individual shelf carries nothing but identical articles. However, systems which are able to perform a reliable and sensitive detection and charging (indifferent on which of the shelves an article may have been put back) a preferred as compared to systems which perform a combination of the detection of individual goods and of the mere detection that an access or a removal has taken place.

Preferably, the system together with the integrated detecting device is basically operated as follows (regardless whether it is a “high end” or a “low cost” system):

Before starting the system, it is initialised. That means that all different types of products, their nominal weight (or, preferably, the possible range of their weight) and their price are entered into the data processing system 5. If necessary the range of products to be dispensed is tuned as already described. Next at least one dispenser 1 is filled up. Preferably the person filling the dispenser 1 enters the type and the number of articles into the data processing system 5 or, at least, it enters into the system that the dispenser 1 is correctly filled up. To simplify the data input, the use of a commercial bar code scanner may be used. However, this is not compelling. The system itself may detect the initial load of the dispenser 1 by a cycle as described hereinafter. The system is ready now.

Basically the detection works as described in the following:

If the guest removes a product from the tray 10 the load sensors 12 signalise a different load. The set of signals of the load sensors 12 or the weight of the shelf s load calculated therefrom or an intermediate data for calculating the shelf s load (hereinafter indiscriminately “the load data”) is stored. The present load data is compared to formerly stored load data. Thereby the difference in the shelf s load and the identity of the product producing said difference can be calculated.

Such system needs no shelf having special storing areas (for example deepenings) for the individual articles in order to detect a removal or a placing back of articles. Consequently, the guest has the possibility to remove articles temporarily for the purpose of a closer look at these articles without being charged and without having to make sure that the article is placed back correctly if there is no intention to buy it.

A number of optional measures may be provided in order to improve the detection.

At first it is recommendable not to operate the detection system at all times. It is sufficient if the detection device is activated as soon as it can be expected that the guest will remove a product. Appropriate means for activation are, for example, a door switch, an electronic door lock and sensor module 8, 9, a motion detector or the load sensors itself if the detecting device is of a sufficiently quick kind.

It may be advantageous to operate the detection system from time to time even if it can not be expected that the guest will remove a product. Thereby one may, for example, compensate disturbing effects caused by fluctuations of temperature within the refrigerator compartment. For that purpose a timer may be provided which operates the detection system from time to time in order to refresh the load data stored. The frequency of activation and the length of time delay before the next automatic activation may be adjustable, preferably by remote commands.

Moreover, an improved detecting system will be able to realise, as soon as it is activated, a very quick signal detection (and processing or data storing if necessary), so that it is possible to calculate from the function of load/time whether one article or two or more articles (even if quickly one after another) have been removed. Thereby it is avoided that problems may occur if the combination of two or more articles has the same weight as another article or a combination of other articles.

More simple systems may not be powerful enough for a current real-time detection when activated. Such systems start the detection as soon as it can be assumed that the guest turned (for that time) away from the mini bar. For that purpose, a detection cycle is carried out not before lapse of a predetermined time or not before a trigger signal was received. An appropriate trigger signal may be, for example, generated by the door sensor—as soon as the guest has closed again the door of the mini bar, it can be assumed that he turns away from the mini bar for that time. Consequently the detection whether an article has been removed or placed back (or whether “nothing happened”) can be started now, maybe after a certain lapse of time

FIG. 4 shows a second embodiment of a dispenser for the inventive dispensing system. Again the dispenser 1 is—for purpose of explanation—a mini bar with a box-like casing 2 closed by a door 2a.

Here, the mini bar has two store areas 3 in form of shelves 10. However, a different number of store areas is possible. Above each shelf 10 there is a pick-up equipment 13 in form of a digital camera. Depending on the distance between two following shelves 10 or a shelf 10 and the top 14 of the casing 2, it may be necessary to provide not only one but two or more cameras for monitoring the whole store area 3 of one shelf 10. Preferably the camera is arranged in a centre position. However, different positions are possible. For example if the store area is very narrow so that (for example) only one single row of bottles can be dispensed, the camera may be arranged in a lateral position. Advantageously the lens and/or image detector of the camera are situated in an approximately horizontal plane. The camera is of a high quality. It supplies digital images suitable for a computerised analysis. The camera uses preferably the visible spectre of light for taking pictures. Alternatively, the digital image or images may be infrared. Especially in the fridge compartment of a mini bar it is possible to take pictures using radiation in the infrared spectre. This is because the condenser, usually mounted to the back of the fridge compartment, is a heat sink. Articles placed in the front of the heat sink shadow the heat sink so that a characteristic infrared image is generated.

Appropriate cameras are commercially available.

If the camera is not of an infrared-type, appropriate light sources are provided which are energised at least as long as the camera takes a picture. The light sources make it possible to take a picture even if the door of the mini bar is closed. It may be advantageous to create the light source with a number of light-emitting diodes 15 This diodes 15 are not concentrated at one point but distributed over the lower side of the next following shelf or the roof of the casing 1, So that they provide a very uniformed illumination of the stored articles. A shadowing, which may falsify the recognition of the articles stored, is avoided. Additionally diodes provide no unwanted heat in the fridge compartment. In the same manner diodes are provided over the inner surface of the top 14 of the casing 2 (not shown).

Appropriate data processing programs for analysing digital images in order to detect the presence or the absence of different (rather simple) circular or square items are commercially available. Such programs can be used here. Due to the fact that the camera (of the construction shown by FIG. 4) is arranged above the controlled shelf it “sees” the characteristic circular or square profile of each individual bottle or box to be dispensed. This rather simple but however characteristic profiles allow a sufficient determination of the individual articles to be dispensed by means of image analysis. An important point is that in most cases the guest only removes one single article from the mini bar whereas all other articles keep their position. Therefore it is preferably possible to superpose a newly taken image and a stored image so that wide areas of the newly taken image—namely those areas which remained unchanged compared to the stored image—can be faded out quickly, i. e. such areas need not to be analysed in detail because it can be detected without closer analysis whether a picture of an area remained unchanged. A labour-intensive, detailed analyses of the full image is only required if the mini bar has been refilled or if the guest disarranged not only one (or maybe two) but a greater number of articles.

In order to reduce the hardware power required for the image analysis it is recommendable to tune the choice of products to be dispensed by the system. In other words, the operator of the system should pay attention, that there are no different products which have nearly the same profile. At least the operator has to make sure, that the pricing of such products does not differ.

It is advantageous, to equip such system with an additional camera at a central work place for classifying the profile of all articles in advance (not shown). Such camera may be directly connected to the data processing unit. It provides the system with initial data for the profile of each article to be dispensed. Such camera supports the operator in tuning the system—the camera makes it possible that the system generates at least a warning if the profile of one type of product comes too close to the profile of another type of product. If, for example, the diameter or the profile of a bottle of orange Juice is nearly identical to the diameter or the profile of a bottle of wine then an orange juice in another type of bottle has to be chosen. The colour and more detailed information of the articles may also be assessed to differentiate between articles.

In order to realise a rather simple but—from the viewpoint of price—competitive system, a similar strategy as described in the foregoing paragraphs for the system using load sensors may be used here, too. This means that each individual shelf carries nothing but identical articles. It is not too difficult to detect precisely the absence of individual articles out of a number of identical articles. The guest will be charged as soon as the final removal of an article from one shelf will be detected. The guest may have put this article back to another shelf displaying articles. However, the detection device of this shelf ignores the “unknown” article.

The unjustified charge will be corrected upon complaint by the guest. That way it is made sure that the guest will not leave without being charged for the consumed articles.

Preferably, the system together with the integrated detecting device is basically operated as follows (regardless whether the system is a “high end” or a “low cost” system):

Before starting the system, it is initialised. That means that all different types of products, their profile and their price are entered into the data processing system 5. If necessary the choice of products to be dispensed is tuned, as already described. Next, at least one dispenser 1 is filled up. Preferably, the person filling the dispenser 1 enters the type and the number of articles into the data processing system 5 by various means or, at least, it enters into the system that the dispenser I is correctly filled up. However, this is not compelling. The inventive system may detect the initial load of each dispenser 1 itself by a circle as described hereinafter. The system is ready now.

A real time image analysis is hardly possible by now. Appropriate means, for example a door switch, an electronic door lock and sensor module, a motion detector or a load detector detect activities of the guest with respect to the mini bar. The detection cycle itself is started as soon as it can be assumed that the guest turned (for that time) away from the mini bar. For that purpose the detection cycle is carried out not before lapse of a predetermined time after first activities of the guest have been detected or, preferably, not before a trigger signal was received. An appropriate trigger signal may be, for example, generated by the door sensor—as soon as the guest has closed again the door of the mini bar, it can be assumed that he turns away from the mini bar for that time. Consequently the detection whether an article has been removed or placed back (or whether “nothing happened”) can be started now. For that purpose the camera takes a digital image. This image is analysed by an appropriate software installed in the data processing system 5 so that the characteristic profiles of the individual articles are detected. The results can be compared to the stored results of the analyses of a prior image.

It may be advantageous to operate the detection system from time to time, even if no intervention by the guest has been detected. Thereby, one may, for example, compensate more or less slight displacements of individual articles caused by vibration of the chiller (if the mini bar should have one) or by some kind of external vibration or shock for example. For that purpose a timer may be provided which operates the detection system from time to time in order to refresh the data stored. The frequency of activation and the length of time delay before next automatic activation may be adjustable, preferably by remote commands.

FIGS. 5 and 6 show a third embodiment of a dispenser for the inventive dispensing system. Again the dispenser 1 is—for purpose of explanation—a mini bar with a box-like casing 2 closed by a door 2a.

The mini bar has two shelves 10 and three store areas 3. It does not need to be mentioned explicitly that the number of shelves and store areas can be varied from one to a plurality. The walls confining the store areas 3 , respectively shelves 10, carry a plurality of laser emitter heads 16 and digital detector heads 17, whereby each wall may carry emitter heads 16 as well as detector heads 17. Preferably, the storing area 3 of the bottom and the storing area 3 of each shelf 10, as well as the down facing side of each next upper shelf 10 and the top wall carry emitter heads 10 and detector heads 17, too (not shown). At least the emitter heads and/or detector heads installed in the storing areas 3 may be protected against the spill of liquids by a sealed pane of transparent material like glass or appropriate plastics. Thereby, a three dimensional curtain of laser beams can be obtained. Preferably, not individual emitter and detector heads are used but prefabricated circuit boards comprising array of heads each.

If the distance of the single laser beams (i. e. the density of the curtain) is chosen in an appropriate manner it becomes possible to detect the individual articles by means of their characteristic shadows, as roughly sketched in FIG. 6.

The analysis of the shadow image is performed under application of the general methods for analysis of digital images. The signals of the plurality of detector heads supply actually nothing else then three digital images—even if these images are composed of a rather small number of big “pixels” each. Exactly this is an important advantage of this embodiment. A rather limited power of the hardware is sufficient, even for a quick analysis of the shadow image.

The basic principles of this third embodiment of the dispenser and of the second embodiment of the dispenser are similar to a far extent. Therefore, the above given description of the mode of operation for the second embodiment (comprising all hints concerning the mode of operation) applies accordingly to this third embodiment.

An alternative embodiment (not shown) may use a detecting sensor arrangement which comprises a Radio Frequency Identification scanner (RFId-scanner) being able to communicate with transponder labels (smart tags) attached to the articles to be dispensed. The scanner is activated as soon as an access to the mini bar is detected, for example by the door switch.

It is preferred to mount the RFId-Scanner close to the opening to the housing of the store area so that each transponder label that passes the opening enters into communication with the RFId-Scanner. Alternatively, it is possible to dimension and to locate the RFId-Scanner in a way that it monitors, when activated, the complete internal space of the housing of the dispenser. In this case it is advantageous if the housing and the door shields the RFId-Scanner as soon as said door is closed. Thereby, it is ensured that a transponder label which is outside of the housing of the dispenser is not monitored anymore as soon as the door of the dispenser is closed. A detecting sensor arrangement using a RFId-scanner is very fail-safe. A special advantage is that such a system allows the guest to store his personal travel utensils (like medicaments or even his own beverages like a can of Coca-Cola) in the mini bar without running the danger to irritate the detection system.

Moreover, such a system allows to dispense articles at different prices which have an identical or very similar profile and/or at least nearly the same weight.

It is preferred that the final detecting sensor arrangement comprises a combination of two or more different types of sensor arrangement, for example a load detecting sensor arrangement and a sensor arrangement based on RFId-technology or a sensor arrangement screening by taking a digital full image. Such a combination improves the reliability of the final detecting sensor arrangement. Moreover, such detecting sensor arrangement offers improved protection against circumvention, for example by placing back an empty bottle, a bottle filled with water or a bottle of cheap champagne bought in the supermarket. In order to give an illustrative example: A detecting sensor arrangement based on load detection protects against the placing back of empty bottles and an added detecting sensor arrangement based on RFId-technology protects against the exchange of bottles.

For more details with respect to the organisation of a dispenser or mini bar according to one of the discussed embodiments again reference is made to FIG. 1. Preferably, each store area 3 comprises its own detecting sensor arrangement 4 and an own communications module 5b. The data generated by the sensor arrangement 4 is processed by a communications module 5b into a form suitable for transmission to the main controller 5c integrated into the dispenser. The communication between the sensor arrangement and the main controller may be wireless. That makes it easier, to change the position of the individual store areas 3 realised as shelves 10 for example, if desired.

As shown by FIG. 1 the main controller comprises a clock circuit, a control logic, an optional comparator circuit and a settable timer logic circuit. The main controller is linked to an access door switch, a refill/reset button, a temperature controller and a lock and status circuit and other sensor and data facilities.

Each dispenser 1 is (for example by a controller communications module Sd) connected via a central communications module Se to the central processor 5f. The connection between the controller of the dispenser 5c via 5d and the central communications module 5e takes place over a modem (wireless) communications method, for example a radio frequency channel (that may be the hotel aerial system). The central communications module 5e is connected with the central processor 5f by modem communications methods as a TCP/IP (MATV) system, a cable data network or even a wireless radio frequency system. (From the viewpoint of costs, a cable data network system is preferred.)

A wireless communication of the controller 5c and 5d of the dispenser and the central communications module 5e facilitates the emplacement of the dispenser, especially if it is a mini bar—the mini bar can be placed wherever it is desired, without regard to the existence of a communications cable.

It is possible to use one central communications module 5e in order to connect a group of dispensers 1 to the central processor 5f. An example for this may be a hotel system, where one or more (two or more) mini bars or dispenser may be installed in one or more rooms (a mini bar) and, may be, a dispenser for toilet articles are installed per suite. Such system is shown by FIG. 7.

The interplay of the individual dispenser 1 and the central processor 5f will be explained subsequently on the basis of a mini bar equipped with a detecting sensor arrangement 4 comprising a digital camera.

For the image analysis a powerful hardware is required. Therefore the image analysis is preferably not performed by the individual mini bar itself.

Upon activation the mini bar takes an image of the store area 3 to be monitored. The data of this digital image is transferred to the main controller 5c. There it is collated and preferably assessed whether there has been any change or not. If a change is detected, the data is processed into a form suitable to be transferred to the central processor 5f. Optionally the information “no change”, if there is none, can be generated and transferred to the central processor 5f.

The transfer to the central processor 5f can be done at once or from time to time upon request of the central processor 5f. The central processor 5f processes the information “no change” or analyses the received data by comparing it with the stored data of a formerly taken image. The removed or placed back articles are identified so that the administering system for billing and/or administering the stock of articles available to be dispensed can be provided with according data.

The data of a formerly taken picture (it does not necessarily have to be data of the last picture taken) is cleared, the data of the newly taken picture is stored in order to allow a comparison with the data of a subsequently taken picture. If it is—for whatever reason—not possible to identify the removed article, a message is generated, that the concerned mini bar has to be assessed by the service team.

Especially if the dispenser 1 is equipped with a detecting sensor arrangement 4 requiring less data processing power, it is possible that all or at least the major part of the data processing is managed by the individual dispenser itself.

An example may be a mini bar equipped with a detecting sensor arrangement 4 using load sensors.

The processing of the signals delivered by the load sensors is rather easy. Therefore the main controller 5c of the mini bar manages all data processing. The central processor 5f provides the main controller 5c with all information required to calculate the identity of the removed goods as well as the weights of the different goods to be dispensed. As soon as the removal of an article has been detected the main controller 5c determines the identity of the removed article by comparing former load data to present load data. For the simpler system, the removal of one or more articles denoting a change of state will be recognised. The information that an article has been removed (or placed back) may be transferred to the central processor 5f at once or from time to time upon request of the central processor. If it is—for whatever reason—not possible to identify the removed article, a message is transferred to the central processor 5f that allows to generate the message that the concerned mini bar has to be assessed by the service team.

1. Dispensing system with at least one dispenser (1) for articles that are available to be dispensed, preferably in form of a mini bar, an administering system for billing dis-pensed articles and/or administering the stock of the articles to be dispensed, or at least an interface (6) to such an administering system, said dispenser (1) comprises at least one store area (3), said one store area 3 allows the simultaneous storing of several preferably different articles, whereby the articles can be removed and placed back after inspection by the customer without being charged for the selling price of the articles characterised in that the articles can be freely positioned on the store area (3), and in that said store area is monitored by a detection device which is able to detect at least af-ter a certain time whether an article has been removed independently from the positions in said store area occupied by remaining articles and occupied formerly by said removed article, whereby said detection device comprises a detecting sensor arrangement (4) that generates a signal enabling to calculate the removal of the said removed article and a data processing (5) unit processing said signal by comparing it with stored data deter-mining thus the removal of said removed article for the purpose of billing.

2. Dispensing system according to claim 1 characterised in that the detection device is able to detect additionally the identity of a removed article independently from the positions in said store area occupied by remaining articles and occupied formerly by said removed articles, whereby the sensor arrangement (4) comprised by the detection device generates a signal enabling to calculate the identity of said removed article and whereby the data processing unit (5) processes said signal which allows to calculate the identity by comprising it with stored data determining thus the identity of said removed article for the purpose of billing and/or administering the stock of articles.

3. Dispensing system according to claim 1, characterised in that the detecting sensor arrangement (4) generates in defined intervals a signal depending on the number or the number and/or the identity of the stored articles which is compared by the data processing unit to a prior signal produced by the sensor arrangement in order to determine whether at least one article has been removed in the meantime or to determine whether at least one article has been removed in the meantime and, if so, in order to determine the identity of said removed article.

4. Dispensing system according to claim 3, characterised in that the detection device is composed of a detecting sensor arrangement (4) comprising a store area (3) carried by a means for measuring (12) the load on the store area and a data processing unit (5) comprising means for comparing data of an actual load of the store area with data of a former load of a the store area and means for identifying the dispense of an article and/or the identity of a dispensed article by means of the load difference.

5. Dispensing system according to claim 4 characterised in that the means for measuring (12) the load on the store area comprises at least one piezo-electric load sensor bearing the store area (3) or at least one resistance strain gauge detecting the strain of an elements bearing the store area.

6. Dispensing system according to claims 4 characterised in that the store area is three point beared.

7. Dispensing system according to claim 1 characterised in that the detection device is composed of a detecting sensor arrangement (4) comprising a pick-up equipment (13) that supplies a digital image of the store area (3) and the articles stored in the store area and a data processing unit (5) comprising means for comparing data of an actual image of the store area with data of a former image of the store area and means for identifying the dispense of an article and/or the identity of a dispensed article by means of the difference between the images.

8. Dispensing system according to claim 7 characterised in that the pick-up equipment (13) is arranged above the store area so that it pictures the store area and the articles stored in the store area from above.

9. Dispensing system according to claim 7 characterised in that the pick-up equipment (13) is remote and takes the pictures of the store area by means of a mirror system or a glass fiber optics.

10. Dispensing system according to claim 7 characterised in that the detection device comprises a light source (15) illuminating the dispenser 1 in order to en-able the pick-up equipment (13) to take a picture.

11. Dispensing system according to claim 10 characterised in that the light source (15) comprises one or more incandescent light sources, preferably one ore more diodes or an array of diodes.

12. Dispensing system according to claim 10 characterised in that the light source (15) is arranged in such a way, that the illumination of the stored articles produces no shadowing which falsifies the recognition of the articles stored.

13. Dispensing system according to claim 7 characterised in that infrared rays are used for taking a picture.

14. Dispensing system according to claim 1 characterised in that the detecting device is composed of a detecting sensor arrangement (4) comprising a plurality of sources (16) emitting coherent light, preferably laser diodes, cooperating with an ac-cording number of light detectors (17), said light sources (16) and said light detectors (17) are arranged in such a manner that the stored articles create a shadow image and a data processing unit (5) comprising means for comparing data of an actual shadow im-age with data of a former shadow image and means for identifying the dispense of an ar-ticle and/or the identity of a dispensed article by means of the difference between the shadow images.

15. Dispensing system according to claim 14 characterised in that said sources (16) emit-ting coherent light and said light detectors (17) are arranged in such a way that at least one light curtain is formed.

16. Dispensing system according to claim 15 characterised in that a plurality of light curtains arranged in different planes is formed.

17. Dispensing system according to claim 16 characterised in that the planes of the light curtains are approximately parallel to the surface of the store area.

18. Dispensing system according to claim 16 characterised in that the light beams of at least one light curtain are approximately perpendicular to the light beams of at least one other light curtain.

19. Dispensing system according to claim 16 characterised in that at a plurality of light curtains are provided in a number of different planes, said planes approximately perpendicular to the surface of the store area (13).

20. Dispensing system according to claim 1 characterised in that the detecting device is composed of a detecting sensor arrangement (4) comprising a magnetic field scanner loop which is able to detect a magnetic label attached to the individual article when the article passes said scanner loop and a data processing unit (5) which proc-esses the signal of the magnetic field scanner loop.

21. Dispensing system according to claim 1 characterised in that the detecting device is composed of a detecting sensor arrangement (4) comprising a Radio Frequency Identification scanner (RFId-scanner) which is able to communicate with transponder labels (smart tags) attached to the articles to be dispensed and a data processing unit (5) which processes the signal of the RFId-scanner.

22. Dispensing system according to claim 21 characterised in that the store area and the RFId-scanner are surrounded by a housing (2) with a door opening and a door (2a), whereby said housing (2) and said door (2a) radioshield the RFId scanner as soon as said door is closed.

23. Dispensing system according to claim 22 characterised in that the RFId-scanner is mounted close to the opening of the housing so that each smart tag that passes the opening compellingly enters into communication with the RFId-scanner.

24. Dispensing system according to claim 1 characterised in that the detection device comprises a combination of two or more different detection devices with according detecting sensor arrangements chosen from the five groups of the claims 4 to 6 (load detection), 7 to 13 (screening by full image), 20 (magnetic detection), 14 to 19 (screening by shadow image) and/or 21 to 23 (tagging), whereby the combination preferably comprises detection device chosen from the group of the claims 4 to 6.

25. Dispensing system according to claim 1 characterised in that the dispenser (1) comprises a plurality of store areas (3) not divided into separated compartments whereby two or more or all store areas (3) are monitored by a common detecting sensor arrangement (4) according to one of the claims 4 to 24.

26. Dispensing system according to claim 1 characterised in that the data processing unit (5) comprises a local data processing unit (5c) directly assigned to each dispenser and a central data processing unit (5f) remote from said at least one dispenser (1).

27. Dispensing system according to claim 26 characterised in that the data processing unit (5) comprises an intermediate data processing unit (5e) that is remote but preferably in the vicinity of said at least one dispenser (1) and that is remote from the central data processing unit (5) and that receives data from the at least one dispenser (1), preferably from a group of dispensers (1) in the vicinity, and that forwards said data or data calculated from said data to the central data processing unit (5f).

28. Dispensing system according to claim 26 characterised in that the local data processing unit (5c) assigned to each dispenser comprises at least means for processing the signals received from the detecting sensor arrangement (4) of the assigned store area (3) into a suitable form for onward transmission of data to the intermediate data process-ing unit (5e) or to the central data processing unit (5f).

29. Dispensing system according to claim 28 characterised in that the detecting sensor arrangement (4) is not continuously operated but from time to time.

30. Dispensing system according to claim 29 characterised in that said local data processing unit (5c) comprises a trigger means for triggering a detecting cycle of the detecting sensor arrangement.

31. Dispensing system according to claim 30 characterised in that the trigger means is a means which registers the access to the dispenser, preferably a door sensor or switch (8, 9) and/or a light barrier and/or a motion sensor and/or a load detecting sensor (12) as-signed to the store area and/or a timer that triggers the detecting cycle from time to time.

32. Dispensing system according to claim 30 characterised in that said detecting cycle is not carried out immediately upon triggering by said switch, said barrier or said sensor but after lapse of a predetermined time after triggering.

33. Dispensing system according to claim 28 characterised in that said at least one local data processing unit (5c) comprises additional means for detecting whether there is a difference between a signal newly generated by the detecting sensor arrangement (4) and a signal previously generated by the detecting sensor arrangement (4), means for deciding whether the difference is relevant so that it is required to for-ward data to the intermediate or the central data processing unit (5e, 5f) or not.

34. Dispensing system according to claim 33 characterised in that said at least one local data processing unit (5c) forwards, in case of a relevant difference, data to the interme-diate or the central data processing unit (5e, 5f) which enables the intermediate or the central data processing unit (5e, 5f) to determine whether an article has been dispensed or not and, in case of dispense, the identity of the dispensed article.

35. Dispensing system according to claim 33 characterised in that said at least one local data processing unit (5c) forwards, in case of no relevant difference, a signal “no change since last interrogation”.

36. Dispensing system according to claim 33 characterised in that said local data processing unit (5c) stores the data to be forwarded until interrogated by the intermediate or the central data processing unit (5e, 5f).

37. Dispensing system according to claim 33 to 35 characterised in that the intermediate data processing unit (5e) stores the data to be forwarded until interrogated by the central data processing unit (5f).
